(19) United States
(12) Patent Application Publication
(10) Pub. No.: US 2010/0007057 A1
(43) Pub. Date: Jan. 14, 2010

(54) INJECTION MOLD MANIFOLD AND METHOD OF USING SAME

(76) Inventors: Jan Klestinec, Kansas City, MO (US); Yosif Kushnir, Overland Park, KS (US)

Correspondence Address: HUSCH BLACKWELL SANDERS LLP, 4801 Main Street, Suite 1000, KANSAS CITY, MO, 64112, US

(21) Appl. No.: 12/171,823

(22) Filed: Jul. 11, 2008

(51) Int. Cl. B29C 45/18

(52) U.S. Cl. 264/328.8; 425/572; 264/299

(57) ABSTRACT

A manifold for delivering molten plastic material into a mold cavity for forming generally cylindrical parts such as food and beverage containers having large aspect ratios. The manifold includes a manifold block, an inlet, and at least two outlets in fluid communication with the inlet. The outlets are configured for injecting molten plastic material into a single mold cavity in order to ensure that the molten plastic material reaches the outermost portions of the mold cavity prior to setting up. The manifold can also be configured to be attached to a second manifold in place of a single outlet on the second manifold.

### CROSS-REFERENCE TO RELATED APPLICATIONS

None.

### BACKGROUND OF THE INVENTION

Mass-produced plastic items such as drinking cups and various types of food containers are generally produced under relatively low profit margins. In the production of plastic drinking cups and food containers, such as those distributed at grocery stores, convenience stores, sporting events, concerts, and the like, it is estimated that at least sixty percent of the production cost is related to the raw plastic material used to produce the containers. Therefore, in order to help reduce the amount of plastic material used in each cup, it is ideal to create a container having thin walls.

Plastic drinking cups and containers are often produced using an injection molding process. In the conventionally-known injection molding processes, molten plastic material is injected into the mold through a single port or gate. This single port or gate is located in the center of the bottom wall of the cup or container. The mold is configured such that the cup or container is formed in an upside-down orientation. In these conventionally-known processes, the wall thickness is limited. If the wall thickness, as dictated by the mold cavity, is too thin, the molten plastic material sets up before it reaches the bottom of the mold cavity and the mold cavity will not completely fill with plastic material.

Due to this drawback, thermoforming has become a more prevalent method for producing plastic drinking cups and other containers in recent years because it uses less material. However, the thermoforming process has substantial disadvantages. First, the objects produced by the thermoforming process can only be made of a “natural” tinted material or a white material, but not of a clear material or colored material. Second, the objects produced by the thermoforming process can be flimsy.

Accordingly, a need exists for a device and process that allow plastic items, such as drinking cups and other plastic containers, to be produced from less material, while still having the ability to be made from a clear material or a colored material for enhanced aesthetics. A further need exists for a device and process that allow plastic items, such as drinking cups and containers, to be produced from less material, while still having adequate strength.

### SUMMARY OF THE INVENTION

One embodiment of the present invention is directed to a manifold for delivering molten plastic material into a mold cavity for forming generally cylindrical parts having thin walls. The manifold includes a manifold block, an inlet, and at least two outlets in fluid communication with the inlet. The outlets are circumferentially spaced and configured for distributing the molten plastic material substantially uniformly within a single mold cavity. The manifold may be constructed to be detachably coupled to a second manifold in place of a single outlet on the second manifold.

Another embodiment of the present invention is directed to a method for filling a mold cavity constructed for forming a generally cylindrical part having a large aspect ratio with molten plastic material. The method includes the steps of providing a manifold having at least two outlets configured for distributing molten plastic material within a single mold cavity and causing molten plastic material to be supplied to and ejected from the manifold into a single mold cavity.

A further embodiment of the present invention is directed to an injection molded plastic drinking cup or other container including a bottom wall and an elongated generally cylindrical sidewall extending upward from the bottom wall. The cup or container is formed in an injection mold preferably having three gates proximate the perimeter of the bottom wall of the container.

Other and further objects of the invention, together with the features of novelty appurtenant thereto, will appear in the course of the following description.

### DESCRIPTION OF THE SEVERAL VIEWS OF THE DRAWINGS

In the accompanying drawings, which form a part of the specification and are to be read in conjunction therewith in which like reference numerals are used to indicate like or similar parts in the various views:

FIG. 1 is an exploded bottom perspective view of a manifold;

FIG. 2 is a cross-sectional view taken generally along line 2-2 of FIG. 1, in the direction of the arrows;

FIG. 3 is a cross-sectional view taken generally along line 3-3 of FIG. 1, in the direction of the arrows;

FIG. 4 is a is a bottom perspective view of six manifolds coupled to a primary manifold in accordance with one embodiment of the present invention;

FIG. 5A is a bottom plan view of a drinking cup constructed in accordance with one embodiment of the present invention;

FIG. 5B is a side elevational view of the drinking cup shown in FIG. 5A; and

FIG. 5C is a perspective view of the drinking cup shown in FIG. 5A and 5B with a portion broken away for illustrative purposes.

### DETAILED DESCRIPTION OF THE PREFERRED EMBODIMENTS

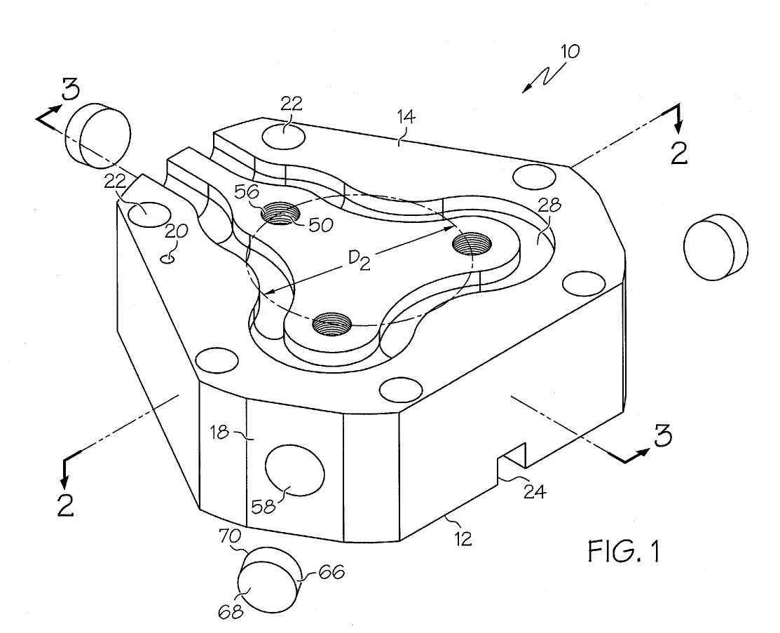

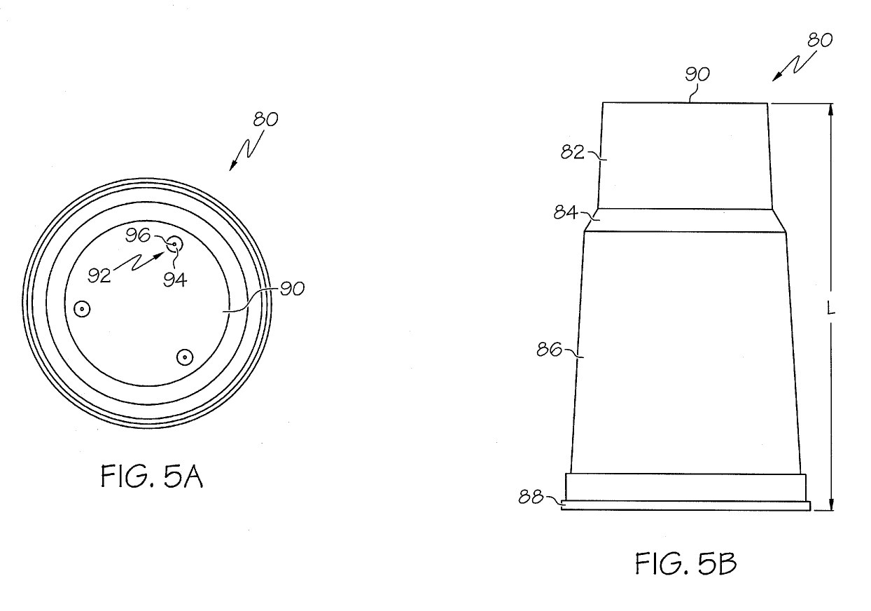

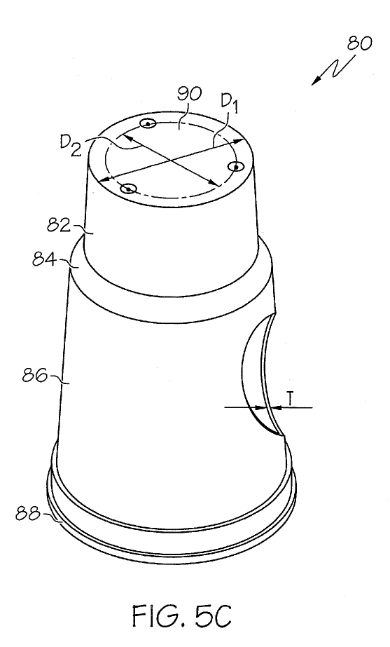

One embodiment of the present invention is directed to a manifold 10 having a plurality of outlets or gates 50 for injecting molten plastic material into a mold cavity (not shown). The manifold 10 shown in FIGS. 1-3 is primarily designed for use when making injected molded items that are generally cylindrical and have elongated walls, such as drinking cups 80 (FIGS. 5A-5C), as well as other types of containers including those used to package various foods.

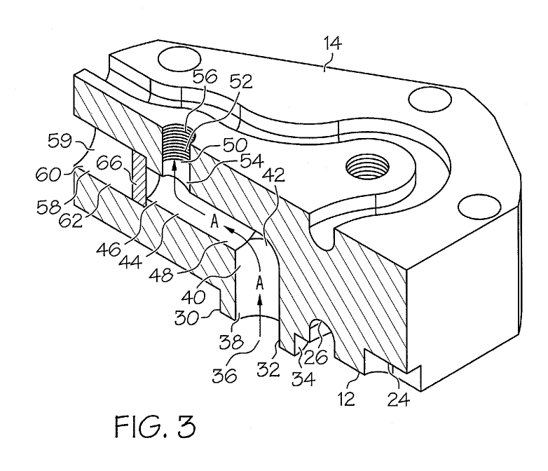

As illustrated in FIGS. 1-3, the manifold 10 includes three outlets or gates 50. These outlets or gates 50 are in fluid communication with an inlet 36 via passages 44. As represented by the arrows A in FIG. 3, an open path, through which molten plastic material can travel, extends through the manifold from the inlet 36 proximate a first or top face 12 and branches out to a number of outlets or gates 50 proximate the opposing second or bottom face 14. While only one inlet 36 is shown in the figures, it is understood that more than one inlet 36 may be possible. For example, there may be one inlet 36 in direct fluid communication with each outlet or gate 50. If a single inlet is provided, the inlet 36 is preferably located at or near the geometric center of the manifold 10.

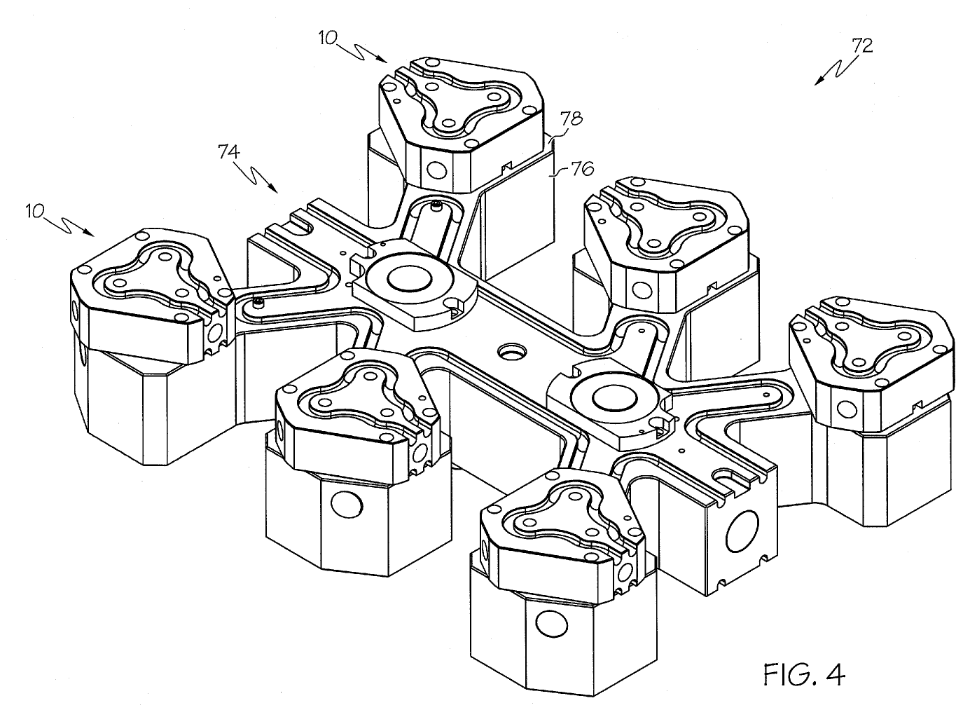

As shown in FIG. 3, the manifold 10 includes a projecting collar 30 proximate the inlet 36. The collar 30 is used to position and locate the manifold 10 when the manifold 10 is coupled with a second manifold 74 (see FIG. 4) or other system in fluid communication with a source of molten plastic material. In order to removably couple the manifold to a second manifold 74 or other system, the collar 30 can be threaded either on its inner surface 32 or its outer surface 34. However, when the manifold 10 includes other means for coupling it to another object, such as apertures 22 for receiving bolts, the collar 30 need not be threaded.

The inlet 36 can be an axial bore having first and second ends 38, 40. The inlet 36 begins at a first end 38 proximate the manifold first face 12 and terminates at a second end 40 located within the interior of the manifold 10 proximate a junction 42.

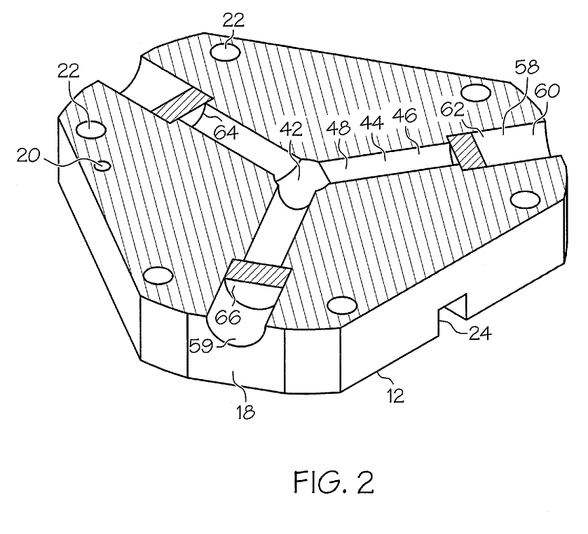

In order to create an open path and communicate molten plastic material from the inlet 36 to the outlets 50, the manifold 10 includes passages 44. As shown in FIG. 2, the passages 44 are radial bores that may diverge from the center of the manifold 10 to the outlets 50. The passages 44 are created by drilling or boring into the manifold 10. In the embodiment shown in the figures, the drilling may be done through corner faces 18. The radial passages 44 and the axial inlet 36 converge and intersect with one another to form a junction 42 in the interior of the manifold 10 near the inlet 36.

The passages 44 have first or outer ends 46 and second or inner ends 48. As illustrated in FIGS. 2 and 3, the outer ends 46 of the passages 44 may be closed by a plug 66 just outside of the outlets 50. The plug has a first face 68 and a second face 70. In order to assist in closing off the outer ends 46 of the passages 44, the manifold 10 can include access bores 58. The access bores 58 have first or outer ends 60 and second or inner ends 62. The diameter of the access bores 58 is larger than the diameter of the passages 44, thereby creating a surface 64 at the second end of each access bore 58.

As shown in FIGS. 2-3, the second face 70 of the plug 66 is seated against the surface 64. The plug 66 may be kept in place by weld, solder, or any other means now known or hereafter developed. Alternatively, the sidewall 59 of the access bore 58 may be threaded and the plug 66 may be kept in place by a threaded fitting (not shown).

The outlets 50 can be axial bores having first and second ends 52, 54. The outlet first ends 52 are proximate the manifold second face 14 and the outlet second ends 54 are located within the interior of the manifold 10 and in fluid communication with the first ends 46 of the passages 44. In use, the outlets 50 may be configured to inject molten plastic material directly into a mold cavity. In other instances, the outlets 50 may be configured to be coupled with nozzles (not shown) that inject the molten plastic material into the mold cavity. In such an instance, the outlets 50 may be configured for receiving the nozzles and contain portions 56 proximate their first ends 52 for coupling the nozzles in a suitable manner.

While the figures show the manifold 10 having three outlets 50, it is understood that the manifold 10 may have any number of outlets 50. With a plurality of outlets 50, the manifold 10 fills the mold cavity in a shorter amount of time because the molten plastic material is injected from multiple locations, as opposed to just one. Additionally, the outlets 50 can be placed proximate areas of the mold cavity where the molten plastic material is required to travel the furthest in order to fill the mold cavity. For example, when producing a cup 80, the outlets can be located near the perimeter of the bottom wall 90, adjacent the cup's sidewall 82. Having multiple outlets 50 and strategically placing them, allows the molten plastic material to reach the bottom portion of the mold cavity before it sets up. This, in turn, allows for the design of mold cavities that can produce items having thinner walls.

As illustrated in the figures, the outlets 50 are circumferentially spaced around the manifold 10 and may be equidistant from each other and from the center of the manifold 10. This aids in uniform distribution of the molten plastic material when producing cylindrical items, such as cups 80. With such a configuration, when the molten plastic material is injected into the mold cavity, the plastic discharging from each outlet 50 reaches the lowermost edge portions of the mold cavity (i.e., the rim 88 of the cup 80) at substantially the same time.

Such a configuration also aids in stabilizing the mold. A mold for producing cups 80 and cup-like items is composed of an outer female mold portion and an inner male mold portion. The gap between the female portion and the male portion forms the mold cavity. In order to produce cups 80 having sidewalls 82, 86 of uniform thickness, the gap between the female mold portion and male mold portion needs to be constant around the entire diameter of the cup 80. If the gap is not constant, then one side of the sidewall 82, 86 will be thicker and the other side of the sidewall 82, 86 will be thinner. Having multiple outlets 50 helps to ensure that the molten plastic material uniformly fills in around the base part of the cup 80 so as to stabilize the female and male mold and prevent the mold portions from shifting or wobbling with respect to one another.

As mentioned above and as shown in FIG. 4, the manifold 10 is constructed to be coupled with a second manifold 74 or system in fluid communication with a source of molten plastic material. The manifold 10 can be detachably coupled to a second manifold 74 having a single outlet. Therefore, the manifold 10 can enable a second manifold 74 to have the ability to inject molten plastic material into a mold cavity via multiple outlets 50, as opposed to the single outlet with which the second manifold was originally equipped.

In coupling the manifold 10 to a second manifold 74 or other system, an alignment aperture 20, a notch 24, and/or a collar 30 can be used to position the manifold 10. The alignment aperture 20 can extend through the entire manifold 10, from its first face 12 to its second face 14, and may be shaped to receive a rod or pin (not shown) protruding from the second manifold 74 or other system. Likewise, the notch 24 provides a recess in the manifold's first face 14 and may be shaped to receive a stub or the like protruding from the second manifold 74 or other system. The manifold 10 may also contain grooves 26, 28 recessed into its first and second faces 12, 14.

The manifold 10 can be constructed from a variety of metallic materials, including steel, steel alloys, combinations thereof, or any other material suitable for such an application. In its construction, the manifold 10 may be made from a solid block. The solid block is then machined, through milling, drilling and lathing, into a manifold 10.

In use, the manifold 10 can be employed in the production of items made from a variety of plastic materials, including those selected from a group consisting of polypropylene, polystyrene, polyethylene, acrylonitrile butadiene styrene (ABS), and combinations thereof. The plastic material can be of a variety of shades or tints, including transparent or colored. In its molten state, the plastic material enters the manifold 10 and is injected into the mold cavity at a high temperature (approximately 500° F., for example) and pressure (for example, approximately 30,000 psi).

FIG. 4 shows an assembly 72 with six manifolds 10 coupled to a larger primary manifold 74. As shown, the larger primary manifold 74 includes six remote pods 76. Each of the remote pods 76 has a single outlet (not shown) located proximate its bottom surface 78 to which the manifold 10 can be coupled in fluid communication. Without the manifolds 10 attached, each of the remote pods 76 is configured to inject molten plastic material into a mold cavity through a single outlet, either directly or via a nozzle. The manifolds 10 can be configured to be detachable coupled to the remote pods 76 in place of a single nozzle.

The manifolds 10 can be constructed such that their inlets 36 receive molten plastic material from the single outlets of the remote pods 76 and distribute it to multiple outlets 50, which then inject it into the mold cavity. Therefore, when attached, the manifolds 10 allow each of the remote pods 76 to inject molten plastic material into a mold cavity through multiple outlets 50, either directly or via equally-sized nozzles. Therefore, the manifolds 10 have the ability to retrofit older, single outlet manifold systems 74 to incorporate the ability to inject molten plastic material into a mold cavity through multiple outlets 50. When the larger primary manifold 74 is used, the multiple mold cavities into which it injects molten plastic material may either be part of the same mold or separate molds.

As mentioned above, the manifold 10 can be used when making injection molded items that are generally cylindrical and have elongated walls, such as drinking cups. A cup 80 typical of one that can be produced using the manifold 10 is shown in FIGS. 5A-5C. It is of the type commonly distributed at convenient stores, sporting events, concerts and the like. As shown, the cup 80 includes a bottom wall 90, a lower sidewall 82, a transition zone 84, an upper sidewall 86 and a rim 88. The sidewall portions 82, 86 can have a frustoconical shape. Alternatively, rather than having two stepped sidewall portions 82, 86, the cup may have just one sidewall portion.

The cup 80 shown in FIGS. 5A-5C has a relatively large “aspect ratio.” Aspect ratio is defined as the ratio of total flow length to average wall thickness. As illustrated in FIGS. 5A and 5B, the cup 80 has a wall thickness T and a total flow length L.

As previously discussed, by having multiple outlets 50, the manifold 10 provides the ability to produce cups 80 having thinner sidewalls 82, 86 than occurs with other equipment. Injection molded cups with dimensions similar to those of the cup shown in FIGS. 5A-5C, produced using a manifold having a single outlet, typically have wall thicknesses of approximately 0.032 inches. Injection molded cups 80 produced using a manifold 10 having three outlets 50 can have a wall thickness T of approximately 0.020 inches. Therefore, injection molded cups 80 that are produced using a manifold 10 having three outlets 50 can be made using only approximately 60% of the plastic material, as compared to injection molded cups that are produced using a manifold having only one outlet. With the thinner sidewalls 82, 86, the molten material solidifies faster than occurs with thicker sidewalls, thereby reducing the cycle time, i.e. the time required by the injection molding system to mold a part.

The total flow length L for cup 80 can range between approximately five and ten inches. Therefore, with a wall thickness T of approximately 0.020 inches, the aspect ratio for cup 80 can range from approximately 250 to 500.

As shown in FIGS. 5A-5C, the cup 80 has three injection sites 92. As can be seen, these injection sites 92 correspond with the outlets 50 of the manifold 10. The injection sites 92 can have a recessed or concave portion 94 and a projecting portion 96 at the exact location where the molten plastic material is injected into the mold cavity.

As shown in FIG. 5C, the injection sites 92 and the manifold outlets 50 can be circumferentially spaced on a circle having a diameter D₂ centered at the center of the cup bottom. As also illustrated in FIG. 5C, the bottom wall 90 of the cup 80 has a diameter of D₁. The ratio of diameter D₂ to diameter D₁ can vary from embodiment to embodiment and in one embodiment is at least 0.6.

The present invention may also be used in a stack mold in which the molds are stacked in a manner well known in the industry. Additionally, while the invention has been described in connection with producing a beverage cup, it has applicability in the molding of other types of containers including those used for packaging of foods such as yogurt, cottage cheese, ice cream and other foods. The terms “food container” as used herein is intended to include a container for holding a beverage.

From the foregoing it will be seen that this invention is one well adapted to attain all ends and objects hereinabove set forth together with the other advantages which are obvious and which are inherent to the structure.

It will be understood that certain features and subcombinations are of utility and may be employed without reference to other features and subcombinations. This is contemplated by and is within the scope of the claims.

Since many possible embodiments may be made of the invention without departing from the scope thereof, it is to be understood that all matter herein set forth or shown in the accompanying drawings is to be interpreted as illustrative, and not in a limiting sense.

What is claimed is:

1. A manifold for delivering molten plastic material into a mold cavity for forming generally cylindrical parts, said manifold comprising:
a manifold block;
an inlet to said manifold block;
at least three outlets in said manifold block in fluid communication with said inlet; and
wherein said outlets are spaced apart and configured for distributing said molten plastic material substantially uniformly within said mold cavity.

2. The manifold of claim 1, wherein said manifold block is configured to be detachably coupled to a second manifold.

3. The manifold of claim 2, wherein said manifold block is configured to be detachably coupled to a manifold having a single outlet to which said manifold block may be coupled.

4. The manifold of claim 1, wherein said manifold comprises three of said outlets.

5. The manifold of claim 1, wherein said outlets are configured for receiving nozzles for injecting said molten plastic material into said mold cavity.

6. The manifold of claim 1, wherein said manifold block defines passages that provide fluid communication between said inlet and said outlets.

7. The manifold of claim 6, wherein said passages have an outer end terminating in a plug.

8. The manifold of claim 1, wherein said generally cylindrical parts are food containers.

9. The manifold of claim 8, wherein each of said containers has a base with a diameter D₁ and said manifold outlets are spaced apart on circle having a diameter D₂ and wherein the ratio of D₂ to D₁ is at least 0.6.

10. The manifold of claim 1, wherein said manifold is constructed from a metallic material selected from a group consisting of steel, steel alloys, and combinations thereof.

11. The manifold of claim 1, wherein said plastic material is selected from a group consisting of polypropylene, polystyrene, polyethylene, acrylonitrile butadiene styrene (ABS), and combinations thereof.

12. The manifold of claim 1, wherein said plastic material is transparent.

13. The manifold of claim 1, wherein said plastic material is colored.

14. A method for supplying molten plastic material to a mold cavity configured for forming a generally cylindrical part, said method comprising the steps of:
providing a manifold in communication with a supply of said molten plastic material, said manifold having at least two spaced outlets configured for distributing said molten plastic material substantially uniformly within said mold cavity;
supplying said molten plastic material to said manifold; and
injecting said molten plastic material simultaneously from said manifold outlets into said mold cavity.

15. The method of claim 14, further comprising the step of coupling said manifold to a second manifold.

16. The method of claim 15, wherein said manifold is coupled to said second manifold in communication with a single outlet located on said second manifold.

17. The method of claim 14, wherein said generally cylindrical part is a food container.

18. A food container formed by the method of claim 17.

19. An injection molded food container constructed by a process comprising injecting molten plastic into a mold for the container at a plurality of spaced apart locations to effect filling of the mold in a manner to form a container bottom and generally cylindrical sidewall extending from said bottom with said spaced apart locations being adjacent to said bottom proximate a perimeter thereof.

20. A food container as set forth in claim 19, wherein said plurality of spaced apart locations comprises three locations spaced substantially equidistantly from each other and substantially equidistantly from a said center of said bottom.
